(19) United States
(12) Patent Application Publication
(10) Pub. No.: US 2024/0283285 A1
(43) Pub. Date: Aug. 22, 2024

(54) INTEGRATED BACKUP POWER SUPPLY ARCHITECTURE

(71) Applicant: Texas Instruments Incorporated, Dallas, TX (US)

(72) Inventors: Jing Ji, Shanghai (CN); Jian Liang, Shanghai (CN); Shih-chao Hsu, Shanghai (CN); Zejing Wang, Shanghai (CN)

(21) Appl. No.: 18/171,480

(22) Filed: Feb. 20, 2023

(51) Int. Cl. H02J 9/06; H02J 7/00; H02M 3/158

(52) U.S. Cl. CPC H02J 9/061; H02J 7/0013; H02J 7/005; H02J 7/007182; H02M 3/158; H02J 2207/20

(57) ABSTRACT

A power system includes a transistor device (e.g., one or more NFETs) is coupled between input voltage and switching node terminals, to provide a variable sense resistance. The system may further include low-side and high-side switching elements, with the low-side switching element coupled between a ground terminal and the switching node terminal, and the high-side switching element coupled between the switching node terminal and an output voltage terminal. The system may be configured to determine its mode of operation, based on primary and backup battery voltages, and enable a corresponding control loop based on that determined mode. With a control loop enabled, the system may be further configured to control the transistor device to provide a variable sense resistor based on a given control parameter. The low-side switching element may be shared by the modes, and external to a chip that includes the high-side switching element and transistor device.

### TECHNICAL FIELD

This description relates to power supplies, and more particularly, to an integrated backup power supply architecture.

### BACKGROUND

Many modern day electronic systems include both a main or primary power supply as well as a backup power supply, to power various applications of the given system and provide a degree of redundancy in case of primary battery failure. For instance, a conventional automotive power supply system usually includes a primary battery (e.g., car battery) and a backup battery. In such a system, the output voltage of the primary battery is in the range of 12 volts to 36 volts, and the output power can be up to around 25 watts. The application systems may have operation voltages different than the output voltage of the primary battery. For example, and continuing with the example of an automotive power supply system, the operation voltage of a controller area network (CAN) or global positioning system (GPS) may be about 5 volts, while the operation voltage of an audio system may be in the range of about 5-10 volts, although there may be other automotive telematics systems. In such cases, the different application systems can be powered off of the primary battery through different power converters that output the needed voltage. The backup battery can be, for example, a nickel metal hydride battery (NiMH) battery, a lithium ferrous phosphate (LiFePO4) battery, or a lithium ion (Li-ion) battery. The backup battery may be rechargeable. A battery health detection circuit can be used to determine when charging is needed. A number of non-trivial issues remain with power supply systems that include a backup battery.

### SUMMARY

In an example, the techniques may be implemented as a power system that includes a high-side switching element, a transistor, and a controller. The high-side switching element is coupled between a switching node terminal and an output voltage terminal. The transistor is coupled between an input voltage terminal and the switching node terminal. The controller includes first, second, and third control outputs, with the first control output coupled to a low-side switching element control terminal, the second control output coupled to a control terminal of the high-side switching element, and the third control output coupled to a control terminal of the transistor.

In another example, the techniques may be implemented as a power system that includes low-side and high-side switching elements, an n-channel field effect transistor (NFET), and a controller. The low-side switching element is coupled between a ground terminal and a switching node terminal. The high-side switching element is coupled between a switching node terminal and an output voltage terminal. The NFET is coupled between an input voltage terminal and the switching node terminal. The controller is configured to: control a low-side switching element to provide a backup battery charging mode; control the low-side switching element to provide a backup battery health monitoring mode; control the low-side and high-side switching elements to provide a boost converter mode; and control the NFET to provide a variable resistance.

In another example, the techniques are implemented as a method for controlling a power system, the power system having a low-side switching element coupled between a ground terminal and a switching node terminal, a high-side switching element coupled between the switching node terminal and an output voltage terminal, and an n-channel field effect transistor (NFET) coupled between an input voltage terminal and the switching node terminal. The method includes: determining, by a controller, a mode of operation, based on a primary battery voltage and a backup battery voltage, the mode of operation including one of a battery health detection mode, a backup battery charger mode, or a boost converter mode; enabling, by the controller, a corresponding control loop based on the determined mode of operation; and controlling, by the controller, the NFET to provide a drain-to-source on-resistance (Rds_on) based on a given control parameter.

### BRIEF DESCRIPTION OF THE DRAWINGS

FIG. 1 illustrates a block diagram of a system having an integrated backup power architecture that includes power converter, battery charger, and battery health monitoring circuitry, in an example.

FIG. 2 illustrates a schematic diagram of a system that includes power converter, battery charger, and battery health monitoring circuitry, and that is susceptible to poor efficiency and sensing accuracy.

FIG. 3 illustrates a schematic diagram of a system having an integrated backup power architecture that includes power converter, battery charger, and battery health monitoring circuitry, in an example.

FIG. 4 illustrates a schematic diagram of a system having an integrated backup power architecture that includes power converter, battery charger, and battery health monitoring circuitry, in another example.

FIG. 5 illustrates a schematic diagram of a controller suitable for use in the systems of FIGS. 3 and 4, in some examples.

FIG. 6 illustrates a schematic diagram of a scaling circuit suitable for use in the controller of the system of FIG. 3, in an example.

FIG. 7 illustrates a schematic diagram of a scaling circuit suitable for use in the controller of the system of FIG. 4, in an example.

FIG. 8 illustrates a schematic diagram of a backup battery assessment circuit suitable for use in the controller of the systems of FIGS. 3 and 4, in some examples.

FIG. 9 illustrates a schematic diagram of a primary battery assessment circuit suitable for use in the controller of the systems of FIGS. 3 and 4, in some examples.

FIG. 10 illustrates a method for controlling a system having an integrated backup power architecture having a power converter, battery charger, and battery health monitoring circuitry, in an example.

### DETAILED DESCRIPTION

Integrated backup power supply architectures are described. In an example, the power system includes low-side and high-side switching elements, and a transistor device that operates as a variable sense resistor. The low-side switching element is coupled between a ground terminal and a switching node terminal, and the high-side switching element is coupled between the switching node terminal and an output voltage terminal. The transistor device, which in some cases is an n-channel field effect transistor or NFET (or a set of NFETs connected in parallel), is coupled between an input voltage terminal and the switching node terminal. The power system may be configured, for instance, to determine its mode of operation, based on a primary battery voltage and a backup battery voltage, and enable a corresponding control loop based on the determined mode of operation. With a control loop enabled, the power system may be further configured to control the transistor device (e.g., one or more NFETs) to provide a drain-to-source on-resistance (Rds_on) based on a given control parameter. In some such examples, the modes of operation include a battery health detection mode, a backup battery charger mode, and a boost converter mode. The control parameter can be, for instance, a control parameter that corresponds to the determined mode of operation. For instance, the given control parameter can be: an input current limit for the boost converter mode; a charging current for the charging mode; or a reference discharge current for the battery health detection mode. Although any number of electronic systems can benefit from using the techniques described herein, one example system is where the power system is part of an automotive telematics system (e.g., for powering GPS, CAN, audio system, or any other automotive telematics system). The electronic system can also be a non-automotive system that includes a primary battery and a backup battery.

### General Overview

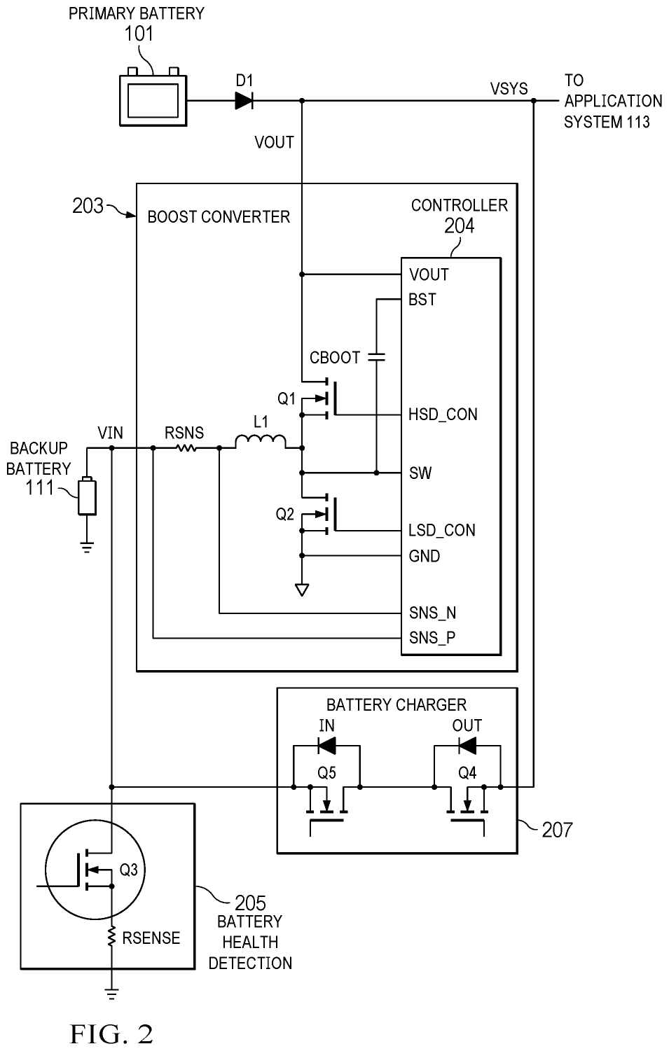

As described above, a number of non-trivial issues remain with power supply systems that include a backup battery. For example, consider a power supply system such as the one shown in FIG. 2, which is susceptible to poor efficiency and sensing accuracy. As shown, the system is configured to provide power to an application system 113 from a primary battery 101 or a backup battery 111. Diode DI prevents reverse current from flowing into primary battery 101. The system has three distinct circuits for backup battery 111, including a boost converter circuit 203, a battery health detection circuit 205, and a battery charger circuit 207. During normal operation, application system 113 receives power (VSYS) from primary battery 101. During boost mode, boost converter circuit 203 is configured to convert output voltage of backup battery 111 to a level of the output voltage of primary battery 101 (e.g., VOUT=12 volts), during periods when primary battery 101 isn't working. In this example, the boost converter circuit 203 includes a controller 204, which for a given input voltage VIN is configured to sense current flow through inductor L1 (by measuring potential across sense resistor RSNS, via the SNS_N and SNS_P terminals), and to control high-side and low-side switching elements Q1 and Q2, so as to provide VOUT. As further shown in this example, a bootstrap capacitor CBOOT is coupled between a bootstrap circuit and switching node (via the BST and SW terminals, respectively) of controller 204. During backup battery monitoring mode, battery health detection circuit 205 is configured to monitor the remaining electricity available in backup battery 111. This can be accomplished, for example, by measuring an internal resistance of backup battery 111, or otherwise assessing the output voltage of backup battery 111. During backup battery charging mode, battery charger 207 is configured to charge backup battery 111 from primary battery 101, when the remaining electricity available in backup battery 111 is detected to be low.

In one such configuration: the boost converter 203 has a 40 volt maximum output voltage, and a 15 amp maximum output current; the battery charger 207 is a linear charger having a maximum output voltage of 40 volts, and a maximum output current of 500 milliamps; and the battery health detection circuit 205 is configured to detect the internal resistance of the backup battery 111 by discharging the backup battery 111 with a certain constant current through a sensing resistor RSENSE coupled to the backup battery 111. As noted above, such a power supply system is susceptible to poor efficiency and sensing accuracy.

In more detail, the three circuits 203, 205 and 207 are independent of one another. For instance: the boost converter circuit 203 includes two power metal oxide semiconductor field effect transistors (MOSFETs) Q1 and Q2 respectively working as high-side and low-side switching elements of the power stage of boost converter circuit 203; the battery health detection circuit 205 includes power MOSFET Q3 to control discharging current through sense resistor RSENSE by controlling a voltage provided at a control terminal of power MOSFET Q3; and the battery charger circuit 207 includes power MOSFET Q4 configured to control the charging current. So, at least four power MOSFETs are utilized for this configuration. The battery charger circuit 207 further includes MOSFET Q5 for isolation between its input terminal IN and output terminal OUT. The four power MOSFETs Q1, Q2, Q3 and Q4 can be expensive depending on the application. For example, for an automotive application which may require relatively high operation voltage (e.g., ˜40 volts) and high current (e.g., ˜20 amps), the cost of each power MOSFET is relatively high. In addition, the battery charger circuit 207 is a linear charger which cannot have a high charging current and has relatively poor efficiency. Even if the linear charger of circuit 207 is replaced, for example, with a DC-to-DC buck charging circuit to increase charging current and improve efficiency, other problems still remain. For example, the power grade and current capability of the three circuits 203, 205 and 207 are different. For instance, in one such example: the boost converter circuit 203 is about 25 watts (with an inductor L1 current of about 15 amps); the battery health detection circuit 205 is about 3.6 watts (with a sensing current of about 1 amp); and the buck charger 207 is about 3.6 watts (with an inductor L1 current of about 3 amps). In such an example, it is difficult to choose a suitable sense resistance for high sense accuracy and efficiency in all three circuits 203, 205 and 207. Considering the maximum power (about 25 watts) of boost converter circuit 203, a 5 mΩ sense resistor can be selected for RSNS to allow for sensing the boost inductor current flowing through inductor L1, but such a relatively small sense resistance may not allow for sufficiently high sensing accuracy in the battery health detection and battery charger circuits 205, 207. So a trade-off must be made.

Techniques are described herein for an integrated backup power supply architecture. The techniques can be used with a number of power converter topologies, and are particularly useful in boost converters having high-side and low-side switching elements. In an example, a transistor device is operatively coupled between the inductor and switching node of the power supply system, and is used to provide a variable sense resistance that can more accurately accommodate diverse sensing needs of different operation modes (e.g., boost converter mode, backup battery health detection mode, and backup battery charging mode). Because the sense resistance is variable, a higher current accuracy can be achieved for each of the operation modes. The transistor device may also support input/output isolation and VOUT short-to-ground protection. In some examples, the techniques allow the low-side switching element to be shared by the different operation modes, and the high-side switching element to be shared by the power converter and battery charging circuits, thus reducing the number of power transistors needed to implement the operation modes. As further explained below, the techniques may allow for higher current capability (as compared to, for instance, a linear charger solution), as well as more flexibility with respect to a wide range power grade.

### Circuit Architecture

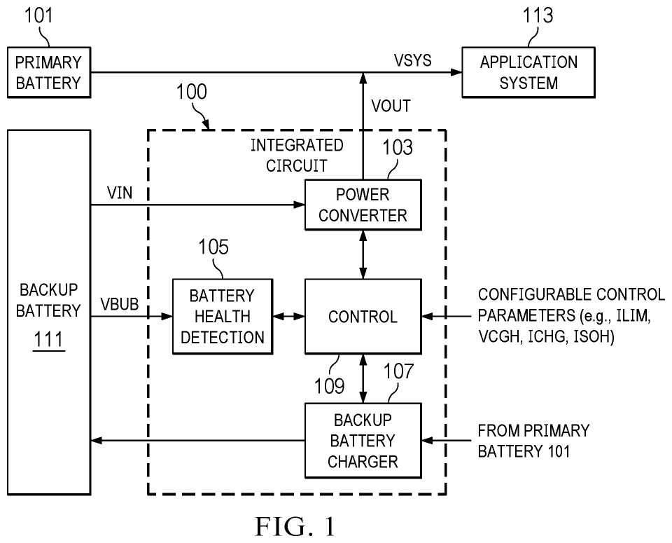

FIG. 1 illustrates a block diagram of a system having an integrated backup power architecture, in an example. As shown, the system is configured to provide power to an application system 113 from a primary battery 101 or a backup battery 111. The system has three circuits for backup battery 111, including a power converter circuit 103, a backup battery health detection circuit 105, and a backup battery charger circuit 107. A control circuit 109 is configured to receive control parameters for a given application, as well as input from circuits 103, 105 and 107, and to provide control signals to each of circuits 103, 105 and 107. As further shown, each of circuits 103, 105, 107 and 109, or parts thereof, can be implemented within a single integrated circuit (IC) 100, which may include one or more die within an IC package. The control parameters can be user-defined or otherwise configurable, so as to allow for application flexibility. This example includes the following control parameters: a power converter input current limit (ILIM), a backup battery target charge voltage (VCHG), a backup battery charging current (ICHG), and a backup battery health detection current (ISOH).

During normal operation, application system 113 receives power (VSYS) from primary battery 101. Power converter mode will engage responsive to failure of the primary battery 101. During power converter mode, power converter circuit 103 is configured to convert VIN from backup battery 111 to VOUT, which corresponds to an expected output voltage level of primary battery 101 (e.g., VOUT=12 volts). Power converter circuit 103 may be any number of power converters, and in one example is a boost converter configured with high-side and low-side switching elements. During backup battery health detection mode, battery health detection circuit 105 is configured to assess the backup battery voltage output (VBUB) or otherwise monitor the remaining electricity available in backup battery 111. During backup battery charging mode, battery charger 107 is configured to charge backup battery 111 from primary battery 101 or power converter circuit 103, when the remaining electricity available in backup battery 111 is detected to be low (e.g., as reported by circuit 105).

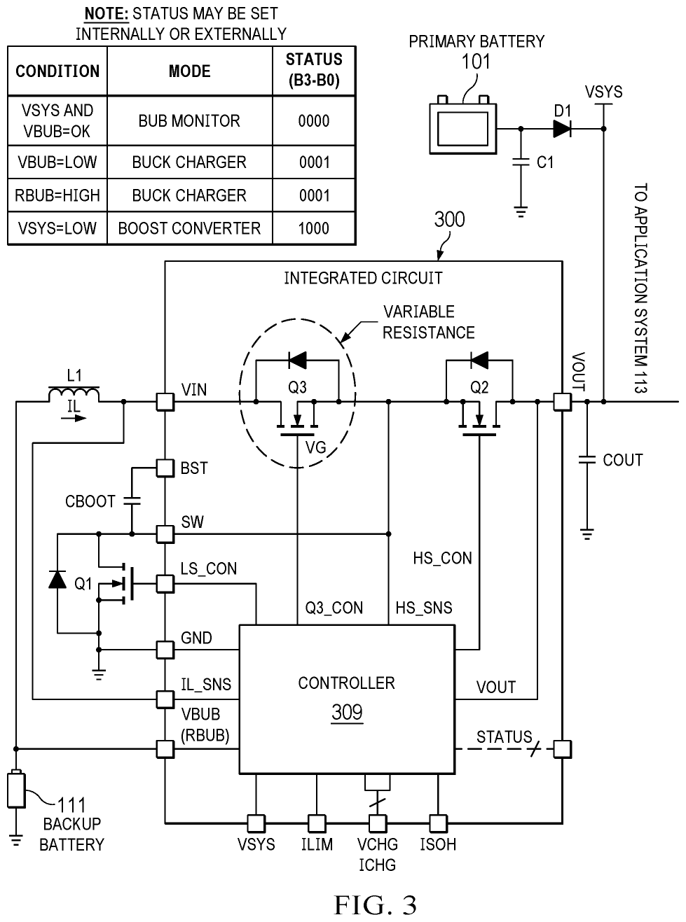

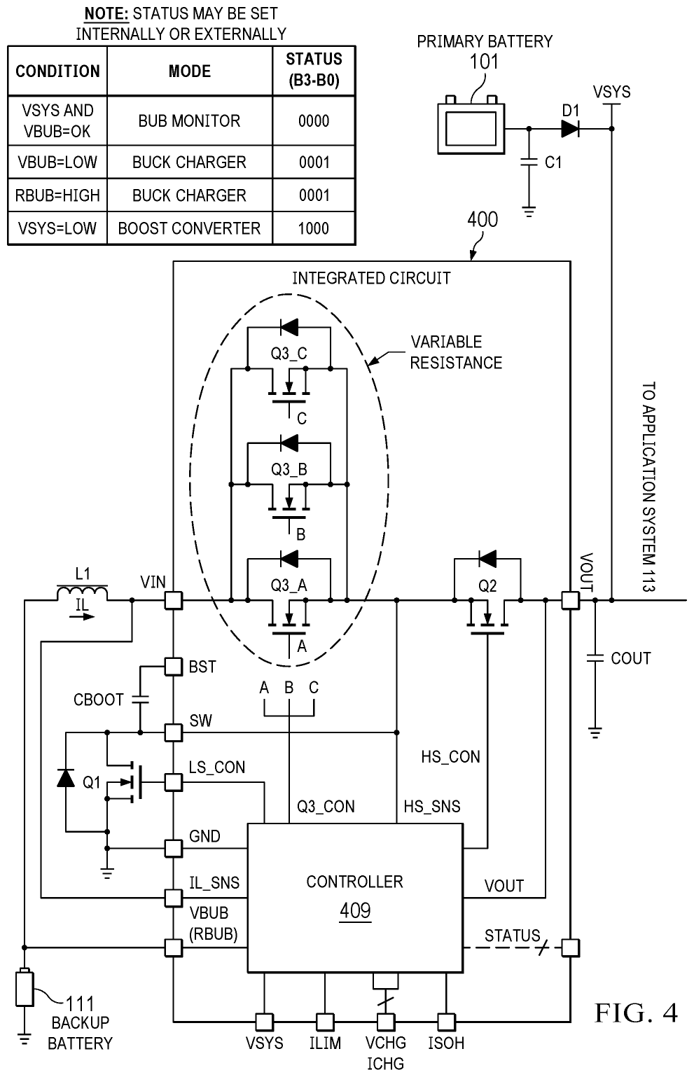

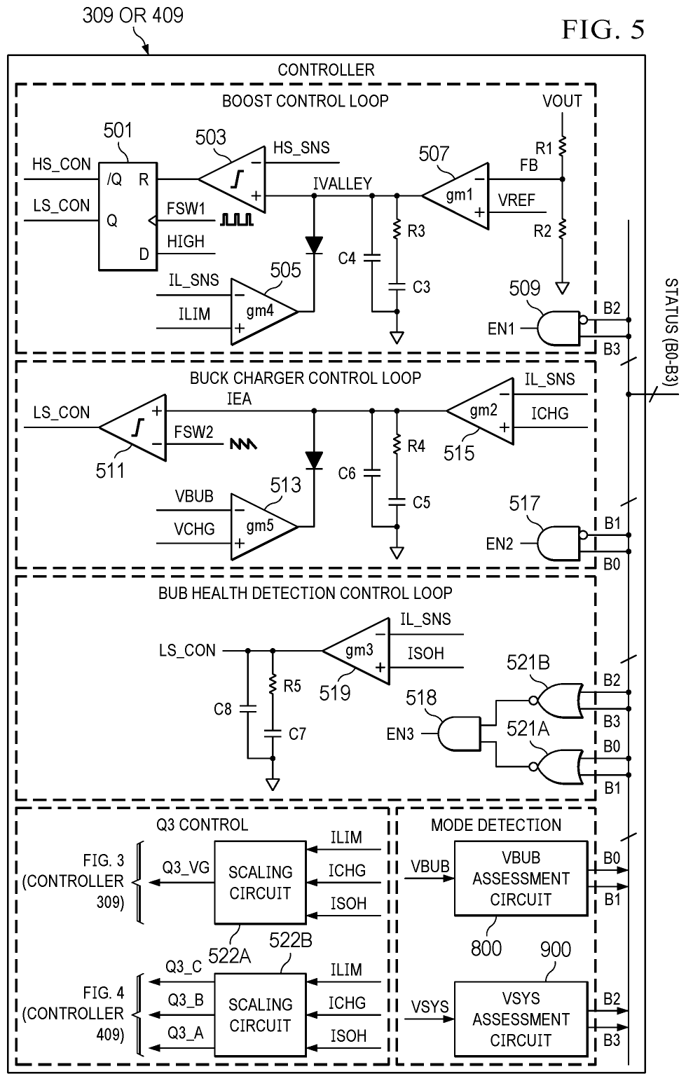

In some examples, power converter mode may have the highest priority. For instance, if primary battery 101 is low, the system will engage power converter mode automatically, even if the charging or battery health detection modes might be needed as well (e.g., as determined by logic, such as that described below with respect to FIGS. 5, 8, and 9. In some cases, the various modes may be enabled, based on a determination by control circuit 109. For instance, in one example case, the charging and battery health detection modes may be controlled or otherwise enabled by enable pins configured to receive control input from circuit 109. Further details of the power supply system are described with reference to FIGS. 3-10.

FIG. 3 illustrates a schematic diagram of a system having an integrated backup power architecture, in an example. As shown, the system is configured to provide power to an application system 113 from a primary battery 101 or a backup battery 111. Capacitor C1 filters high frequency noise on the output voltage terminal of primary battery 101, and diode D1 prevents reverse current from flowing into primary battery 101. The system has three functional modes for backup battery 111, including a boost converter mode, a backup battery (BUB) monitor mode, and a backup battery buck charger mode. Controller 309 is configured to receive control parameters (e.g., ILIM, VCHG, ICHG, ISOH, and VSYS) for a given application, as well as other inputs (e.g., HS_SNS, IL_SNS, VBUB, VOUT, and STATUS), and to provide control signals to each of a low-side switching element Q1, a high-side switching element Q2, and a transistor device Q3, depending on the mode of operation. Transistor device Q3 is coupled between the VIN and switching node (SW) terminals of IC 300, and configured to provide a variable sense resistance based on its control terminal voltage. As further shown in this example, each of controller 309, Q2, and Q3 are implemented within a single integrated circuit package, which may include one or more die therein. The architecture employs, for example, a bi-directional boost or buck topology to accomplish boost converter and buck charger modes.

As shown in this example, low-side switching element Q1 is external to IC 300 and coupled between the switching node (SW) and ground terminals of IC 300. High-side switching element Q2 is internal to IC 300 and coupled between the SW and VOUT terminals of IC 300. Beneficially, Q1 is used in each of the boost converter, buck charger, and battery health detection modes, thus allowing for a lower device count compared to the example shown in FIG. 2. Switching elements Q1 and Q2 can be, for example, power MOSFETs, although any suitable switching element technology can be used. Also, because shared Q1 is external to IC 300, its thermal budget beneficially can be offloaded from IC 300. For example, assume the output voltage of backup battery 111 is about 3.6 volts and the discharge current during battery health detection mode is about 1 amp. In such a case, the power dissipation during battery health detection mode is about 3.6 watts, which can be off-loaded from IC 300 if Q3 is external. Other examples may include low-side switching element Q1 within IC 300. Q1, Q2, and Q3 are implemented with NMOS FETs. The intrinsic body diode is shown, coupled from the respective source (anode) to the respective drain (cathode). Other examples may be implemented with other suitable transistor technologies.

With further reference to the example of FIG. 3, the VIN terminal of IC 300 is coupled to backup battery 111, and the VOUT terminal of IC 300 is coupled to primary battery 101 (via the VSYS node) and the application system 113. An inductor L1 is coupled between the VIN terminal of IC 300 and the output terminal of backup battery 111. Transistor device Q3 is internal to IC 300 and is coupled between the VIN terminal and the SW terminal of IC 300. Transistor device Q3 can be, for example, a power MOSFET, or a laterally-diffused metal-oxide semiconductor FET (LDMOS FET, or LD FET), although other transistor technologies can be used. A boot capacitor CBOOT is external to IC 300 and coupled between a boot strap circuit (BST) terminal and the SW terminal. The boot strap circuit (not shown) can be implemented with any suitable boot strap circuitry. An output capacitor COUT is external to IC 300 and coupled between the VOUT and ground terminals.

Controller 309 of this example includes three control outputs: LS_CON, HS_CON, and Q3_CON. In this example, control output LS_CON is coupled to the LS_CON terminal of IC 300, which is in turn coupled to the control terminal (e.g., gate) of low-side switching element Q1. Control output HS_CON is coupled to the control terminal (e.g., gate) of high-side switching element Q2. Control output Q3_CON is coupled to the control terminal (e.g., gate) of transistor device Q3. Controller 309 further includes a number of inputs: VBUB (or RBUB), VOUT, IL_SNS, GND, HS_SNS, VSYS, ILIM, VCHG, ICHG, ISOH, and STATUS. Input VBUB (or RBUB) is coupled to the VBUB (or RBUB) terminal of IC 300, which is in turn coupled to the output terminal of backup battery 111. Input VOUT is coupled to the VOUT terminal of IC 300, which is in turn coupled to application system 113 and the VSYS node. Input IL_SNS is coupled to the IL_SNS terminal of IC 300, which is in turn coupled to the VIN terminal of IC 300 and the inductor L1. Input HS_SNS is coupled to the HS_SNS terminal of IC 300, which is in turn coupled to the SW terminal of IC 300. These third and fourth inputs (IL_SNS and HS_SNS) allow the inductor LI current passing through transistor device Q3 to be sensed by controller 309. Fifth input VSYS is coupled to the VSYS terminal of IC 300, which is in turn coupled to the VSYS node. Sixth input ILIM is coupled to the ILIM terminal of IC 300. Seventh and eighth inputs VCHG and ICHG are coupled to the VCHG and ICHG terminal(s) of IC 300. Ninth input ISOH is coupled to the ISOH terminal of IC 300. Each of the sixth through ninth terminals of IC 300 may be in turn coupled to, for example, a reference circuit or a user interface that provides the corresponding control parameter (e.g., ILIM, VCHG, ICHG, ISOH). In this manner, controller 309 can be configured for a given application. Tenth input of controller 309 is coupled to the STATUS terminal(s) of IC 300, which allows the controller to receive input from external to IC 300. As such, STATUS may be set internally to controller 309 or externally such as by user input or input from an external circuit. STATUS can be used to set the mode of the system based on sensed conditions and/or external input, as further described below with reference to examples of FIGS. 5, 8, and 9. In this example case of FIG. 3, the modes include a boost converter mode, a buck charger mode and a backup battery health detection mode, and STATUS is a 4-bit code. Other examples may be configured differently.

In the boost converter mode, controller 309 is configured to switch switching elements Q2 and Q1 alternately to operate the circuit as a boost converter to convert a backup battery 111 output voltage provided at the VIN terminal of IC 300 to a higher voltage VSYS at the VOUT terminal of IC 300, for use by the application system 113. In the buck charger mode, controller 309 is configured to switch switching elements Q2 and Q1 alternately to operate the circuit as a buck converter to charge the backup battery 111 from primary battery 101 in a, for example, constant current/constant voltage (CC/CV) charging scheme. In the backup battery health detection mode, controller 309 is configured to measure an internal resistance of backup battery 111 by sensing the inductor current IL (via transistor device Q3). Compared to the example backup power system illustrated in FIG. 2, this integrated backup power supply architecture saves two power MOSFETs, and has higher charging current capability.

In one example, the transistor device Q3 includes an n-channel metal oxide semiconductor (NMOS) power FET coupled between the inductor L1 and the switching node of the power converter (which in this example is between the VIN and SW terminals of IC 300) to sense the inductor current of the three circuits for battery health detection, buck charger in constant current mode, and input current limit of the boost converter. In more detail, by controlling the gate voltage (VG) of Q3, the drain-to-source on-resistance (Rds_on) of Q3 can be scaled internally according to current level (e.g., lower current, greater sense resistance) of the current through the inductor L1. This in turn allows for high accuracy (e.g., +/−10% or better) for a wide range of current (e.g., 50 milliamps to 2 amps). In addition, the body diode of transistor device Q3 (e.g., NMOS FET) supports true shutdown in response to Q3 being off, and short protection in response to the VOUT terminal being shorted to ground. Such true shutdown and short-circuit protection features beneficially help prevent or otherwise reduce current flowing from the VIN terminal to the VOUT terminal of IC 300.

In operation, controller 309 is configured to: control the low-side switching element Q1 to provide a backup battery charging mode; control the low-side switching element Q1 to provide a backup battery health monitoring mode; control the low-side and high-side switching elements Q1 and Q2 to provide a boost converter mode; and control the transistor device Q3 to provide a variable resistance. In some cases, controller 309 includes control circuitry for each mode of operation, as well as scaling circuitry and mode detection circuitry. The control circuits are configured to provide a control loop for each corresponding mode of operation. The scaling circuitry is configured to control the transistor device Q3 to provide a variable sense resistance, based on the mode of operation. The mode detection circuitry is configured to determine: a) if backup battery 111 has an output voltage or resistance within a target range and determine; and b) if primary battery 101 has an output voltage within a target range. Examples of each of the control circuitry, scaling circuitry, and mode detection circuitry of controller 309 are described below with reference to FIGS. 5 through 9.

FIG. 4 illustrates a schematic diagram of a system having an integrated backup power architecture that includes power converter, battery charger, and battery health monitoring circuitry, in another example. As shown, the system is similar to the one shown in FIG. 3, except that this system includes multiple transistors connected in parallel for transistor device Q3 (which in this example includes Q3_A, Q3_B, and Q3_C), each controlled by a corresponding output of controller 409. The above relevant description is equally applicable here. Like controller 309 of FIG. 3, controller 409 is configured to receive control parameters (e.g., ILIM, VCHG, ICHG, ISOH, and VSYS) for a given application, as well as other inputs (e.g., HS_SNS, IL_SNS, VBUB, VOUT, and STATUS), and to provide control signals to each of a low-side switching element Q1, a high-side switching element Q2, and transistor device Q3, depending on the mode of operation. In this case, transistor device Q3 is still coupled between the VIN and switching node (SW) terminals of IC 400, but is configured to provide a variable sense resistance based on which control terminal is driven by controller 409. As further shown in this example, each of controller 409, Q2, and Q3 are implemented within a single integrated circuit package, which may include one or more die therein. The architecture employs, for example, a bi-directional boost or buck topology to accomplish boost converter and buck charger modes.

As shown in this example, low-side switching element Q1 is external to IC 400 and coupled between the SW and ground terminals of IC 400. High-side switching element Q2 is internal to IC 400 and coupled between the SW and VOUT terminals of IC 400. Beneficially, Q1 is used in each of the boost converter, buck charger, and battery health detection modes, thus allowing for a lower device count compared to the example shown in FIG. 2. Switching elements Q1 and Q2 can be, for example, power MOSFETs, although any suitable switching element technology can be used. Also, because shared Q1 is external to IC 400, its thermal budget beneficially can be offloaded from IC 400; other examples may include Q1 within IC 400.

With further reference to the example of FIG. 4, the VIN terminal of IC 400 is coupled to backup battery 111, and the VOUT terminal of IC 400 is coupled to primary battery 101 (via the VSYS node) and the application system 113. An inductor L1 is coupled between the VIN terminal of IC 400 and the output terminal of backup battery 111. Transistor device Q3 is internal to IC 400 and is coupled between the VIN terminal and the SW terminal of IC 400. Each transistor included in transistor device Q3 can be, for example, a power MOSFET, or a laterally-diffused metal-oxide semiconductor FET (LDMOS FET, or LD FET), although other transistor technologies can be used. Three parallel-connected transistors are shown in this example, but other examples may include N parallel-connected transistors, where N is an integer greater than 1, and with each transistor making up the transistor device Q3 configured to receive a corresponding control signal from controller 409. IC 400 may be further coupled to external capacitors CBOOT and COUT, as described above.

Similar to controller 309, example controller 409 includes a number of inputs and control outputs, except that in this example configuration control output Q3_CON includes multiple outputs so as to provide a control signal for each of the transistors making up transistor device Q3. Control signal A is applied to the control terminal of Q3_A, control signal B is applied to the control terminal of Q3_B, and control signal C is applied to the control terminal of Q3_C. Also similar to the system of FIG. 3, the mode of the system in FIG. 4 can be set based on sensed conditions and/or external input. In this example, the modes include boost converter mode, buck charger mode and backup battery health detection mode. The above relevant discussion with respect to operation modes is equally applicable here.

In one example, the transistor device Q3 includes three parallel-connected NMOS power FETs coupled between the inductor LI and the switching node of the power converter (which in this example is between the VIN and SW terminals of IC 400) to sense the inductor current of the three circuits for battery health detection, buck charger in constant current mode, and input current limit of the boost converter. In more detail : the gate of Q3_A can be driven by control signal A to provide a first Rds_on (while Q3_B and Q3_C remain off); the gate of Q3_B can be driven by control signal B to provide a second Rds_on (while Q3_A and Q3_C remain off); and the gate of Q3_C can be driven by control signal C to provide a third Rds_on (while Q3_A and Q3_B remain off). In this manner, the Rds_on of the Q3 transistor device can be scaled internally according to current level (e.g., lower current, greater sense resistance) of the current through the inductor L1. This in turn allows for high accuracy (e.g., +/−10% or better) for a wide range of current (e.g., 50 milliamps to 2 amps). In addition, the body diodes of transistor device Q3 (e.g., each parallel-connected NMOS FET has a respective body diode) support true shutdown in response to Q3 being off, and short protection in response to the VOUT terminal being shorted to ground. Such true shutdown and short-circuit protection features beneficially help prevent or otherwise reduce current flowing from the VIN terminal to the VOUT terminal of IC 400.

In operation, controller 409 is configured to: control the low-side switching element Q1 to provide a backup battery charging mode; control the low-side switching element Q1 to provide a backup battery health monitoring mode; control the low-side and high-side switching elements Q1 and Q2 to provide a boost converter mode; and control the transistor device Q3 (including individually controllable Q3_A, Q3_B, and Q3_C) to provide a variable resistance. In some cases, controller 409 includes control circuitry for each mode of operation, as well as mode detection circuitry and scaling circuitry. Examples of each of the control circuitry, scaling circuitry, and mode detection circuitry of controller 409 are described below with reference to FIGS. 5 through 9.

### Control Circuitry

FIG. 5 illustrates a schematic diagram of a controller suitable for use in the systems of FIGS. 3 and 4, in some examples. As shown, the controller 309, 409 includes several control loop circuitry for each of three operating modes, as well as mode detection circuitry and Q3 control circuitry. The operating modes of this example include boost converter mode, buck charger mode, and backup battery health detection mode; other examples may have other operation modes.

In the boost converter mode, the sensed inductor current IL_SNS is received by the boost control loop and compared with a boost input current limit reference ILIM by amplifier 505 (gm4), to provide an average current limit. In this example, the boost converter is configured to operate at a fixed frequency with a valley current control mode. In other examples, the boost converter can operate in other control modes, such as fixed frequency with peak current control mode, adaptive on-time control, or adaptive off-time control, or other control modes. Assuming a fixed frequency with a valley current control mode, and with further reference to the example of FIG. 5, a difference between a reference voltage VREF and a feedback voltage FB representative of the output voltage VOUT is generated by amplifier 507 (gm1), and sampled as IVALLEY. The reference voltage VREF may be provided, for example, by a bandgap voltage reference (e.g., such as a Brokaw or Widlar bandgap voltage reference), which may be, for example, on-board controller 309 or 409, or IC 300 or 400, or an external circuit. In this example of FIG. 5, feedback voltage FB is provided by a resistive divider circuit coupled to the VOUT terminal and including resistors R1 and R2.

In boost mode operation, a current flowing through the high-side switching element Q2 during the Q2 on-phase is sensed as HS_SNS and compared with IVALLEY by amplifier 503 (edge-triggered comparator), to control turn-off of low-side switching element Q1. Amplifier 505 compares sensed inductor current IL_SNS with ILIM reference to clamp IVALLEY. Responsive to sensed inductor current IL_SNS reaching ILIM, IVALLEY is clamped by operation of the diode coupled between the non-inverting input of amplifier 503 and the output of amplifier 505. A fixed frequency clock FSW1 is used to control turn-on of low-side switching element Q1. In more detail, responsive to sense current HS_SNS being lower than IVALLEY, flip-flop 501 is reset so that low-side switching element Q1 is turned on and high-side switching element Q2 is turned off (via the LS_CON and HS_CON control signals, respectively), and responsive to next pulse of clock signal FSW1, low-side switching element Q1 is turned off and high-side switching element Q2 is turned on (again, via the LS_CON and HS_CON control signals, respectively). The frequency of clock signal FSW1 can be an on-board clock source having the fixed frequency of the boost converter, in an example. The sensed inductor current L_SNS may be sensed, for example, using a current mirror to sense Q3 current; similarly, HS_SNS may be sensed, for example, using a current mirror to sense Q2 current. The ILIM reference can be, for example, provided by a user or a fixed current reference (onboard or external). The RC network on the output of amplifier 507 includes resistor R3 and capacitors C3 and C4, and provides compensation for loop stability.

In the buck charger mode, the sensed inductor current IL_SNS is received by the buck charger control loop and compared with a given constant charge current reference ICHG by amplifier 515 (gm2) to generate the IEA signal. The IEA signal is compared via amplifier 511 (edge-triggered comparator) with fixed frequency ramp signal FSW2. Amplifier 513 (gm5) compares the backup battery voltage VBUB with a target charging voltage VCHG to clamp IEA, responsive to the charging process being complete. Fixed frequency ramp signal FSW2 is used to control turn-on of low-side switching element Q1. In more detail: responsive to IEA being higher than ramp signal FSW2, low-side switching element Q1 is turned on (via the LS_CON control signal generated by amplifier 511); and responsive to IEA being lower than ramp signal FSW2, low-side switching element Q1 is turned off. High-side switching element Q2 is controlled complementary to low-side switching element Q1. Also, responsive to backup battery voltage VBUB being close to target charging voltage reference VCHG, the IEA signal is clamped by operation of the diode coupled between the non-inverting input of amplifier 511 and the output of amplifier 513, thereby decreasing the charging current to zero to complete and cease charging of backup battery 111.

Clock signal FSW2 can be generated, for example, by a fixed frequency ramp generator (on-board or external), such as a circuit that periodically charges and discharges a capacitor based on a switching frequency of the buck charger. The sensed inductor current L_SNS may be sensed, for example, using a current mirror to sense Q3 current, as described above. The ICHG reference can be, for example, provided by a user or a fixed current reference (onboard or external). Similarly, the VCHG reference can be, for example, provided by a user or a fixed voltage reference (onboard or external). The RC network on the output of amplifier 515 includes resistor R4 and capacitors C5 and C6, and provides compensation for loop stability.

In the battery health detection mode, the sensed inductor current IL_SNS is received by the backup battery health detection control loop and compared with a given discharge current reference ISOH by amplifier 519 (gm3). In operation, amplifier 519 is configured to control a discharging current based on a difference between IL_SNS and ISOH, by controlling low-side switching element Q1. The ISOH reference can be, for example, provided by a user or a fixed current reference (onboard or external). The RC network on the output of amplifier 519 includes resistor R5 and capacitors C7 and C8, and provides compensation for loop stability.

As further shown in FIG. 5, each of the boost control loop, buck charger control loop, and battery health detection control loop can be selectively enabled based on respective enable signals EN1, EN2 and EN3, which can be set through a logic circuit based on, for example, the STATUS signal received at the status control terminal, or via mode detection circuitry. Only one control loop is active at any given time. Also, each individual control loop receives one or more given control parameters (e.g., ILIM, VCHG, ICHG, ISOH, and VSYS), at least some of which may be used by the Q3 control circuitry to scale or otherwise control the sense resistance provided by transistor device Q3 to further refine performance of the operation mode corresponding to that control loop (e.g., to provide a desired inductor current with higher accuracy).

Operation of the controllers 309 and 409 according to some examples may be as follows. To facilitate ease of description, controller will be generally used, which may be either of controller 309 and 409. As shown in FIG. 5, controllers 309 and 409 are the same, except for the Q3 control. In particular, controller 309 of FIG. 3 employs scaling circuit 522A, which is configured to vary the gate voltage of a transistor device Q3 that is made up of a single transistor, according to one example; and controller 409 of FIG. 4 employs scaling circuit 522B, which is configured to drive one gate of a transistor device Q3 that is made up of a set of parallel-connected transistors, according to another example. Such operation is further described below.

### Mode Detection Circuitry

If voltage VSYS of primary battery 101 and voltage VBUB of BUB 111 are both in tolerance, then the mode detection circuitry is configured to enable the BUB health detection control loop (and disable the other two control loops), by setting a 4-bit status code (B3, B2, B1, B0) to 0000, as further described below.

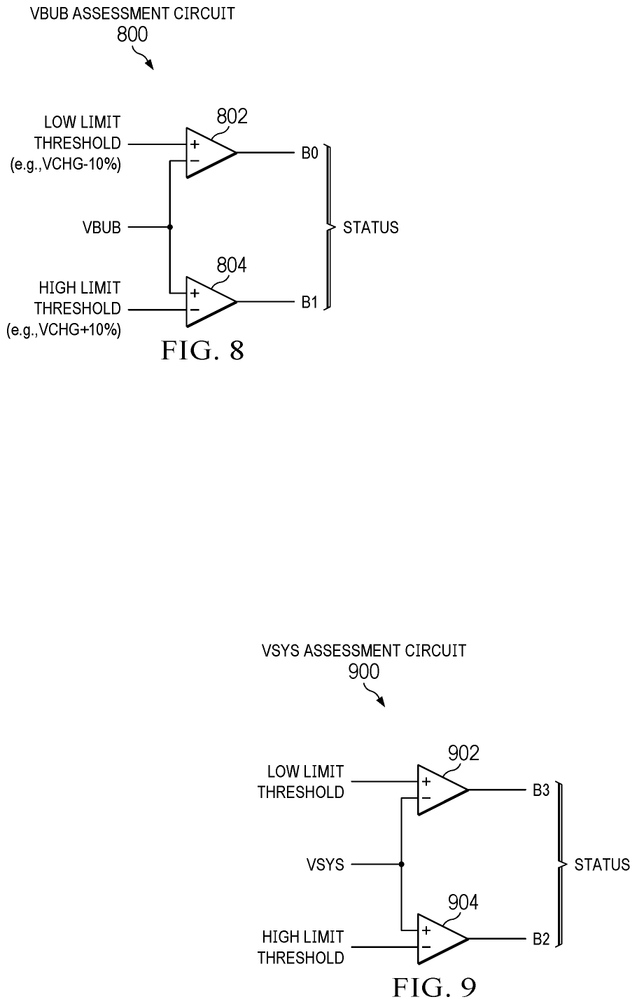

The voltage VBUB can be assessed, for example, via VBUB assessment circuit 800. One example of circuit 800 is shown in FIG. 8. As shown in that example, circuit 800 includes a window comparator circuit implemented with amplifiers 802 and 804. The non-inverting input of amplifier 802 is coupled to a low limit threshold (e.g., VCHG-10%), and the inverting input of amplifier 804 is coupled to a high limit threshold (e.g., VCHG+10%). VBUB is coupled to the inverting input of amplifier 802 and the non-inverting input of amplifier 804. If VBUB is in tolerance (e.g., within the range of VCHG+/−10%), then the outputs of comparators 802 and 804 are both low, thereby providing a 2-bit status code of 00 (bit B1 and bit B0).

The voltage VSYS can be assessed, for example, via VSYS assessment circuit 900. One example of circuit 900 is shown in FIG. 9. As shown in that example, circuit 900 includes a window comparator circuit implemented with amplifiers 902 and 904. The non-inverting input of amplifier 902 is coupled to a low limit threshold (e.g., VSYS−10%), and the inverting input of amplifier 904 is coupled to a high limit threshold (e.g., VSYS+10%). VSYS is coupled to the inverting input of amplifier 902 and the non-inverting input of amplifier 904. If VSYS is in tolerance (e.g., within the range of VSYS+/−10%), then the outputs of comparators 902 and 904 are both low, thereby providing a 2-bit status code of 00 (bit B3 and bit B2).

Referring to FIG. 5, responsive to VSYS and VBUB both being in tolerance, a 2-bit status code of 00 (B0 and B1) is received by NOR-gate 521A, and a 2-bit code of 00 (B3 and B2) is received by NOR-gate 521B. The resulting logic high signals generated by NOR-gates 521A and 521B are received by AND-gate 518, which in turn generates a logic high enable signal EN3, which in turn can be used to enable the health detection control loop. In some cases, for instance, amplifier 519 is enabled responsive to enable signal EN3 being high, and disabled responsive to enable signal EN3 being low. The enable logic (509 and 517) of the other control loops results in enable signals EN1 and EN2 being low, when enable signal EN3 is high. In still other examples, the status code alternatively can be set by a user or otherwise provided via the STATUS terminal. Any number of other control loop enable schemes can be used.

In contrast, if VBUB is low, then the mode detection circuitry is configured to enable the buck charger circuit control loop (and disable the other two control loops), by setting the 2-bit status code (B1, B0) to 01. In more detail, and with further reference to the example VBUB assessment circuit 800 of FIG. 8, if VBUB is low (e.g., lower than VCHG-10%, or some other suitable threshold or tolerance), then the output of comparator 802 is high and the output of comparator 804 is low, thereby providing a 2-bit status code of 01 (bit B1 and bit B0). Responsive to VBUB being low, a 2-bit status code of 01 (B1 and B0) is received by AND-gate 517, which is configured with an inverter on its input that receives B1. The AND-gate 517 in turn generates a logic high enable signal EN2, which in turn can be used to enable the buck charger circuit control loop. In some cases, for instance, amplifier 511 (and amplifiers 513 and/or 515, in some examples) may be enabled responsive to enable signal EN2 being high, and disabled responsive to enable signal EN2 being low. The enable logic (509, 518, and 521A-B) of the other control loops results in enable signals EN1 and EN3 being low, when enable signal EN2 is high. In other examples, the resistance of BUB 111 (RBUB) can be similarly assessed, instead of VBUB, and used to enable the buck charger circuit control loop. The above relevant description with respect to the status code alternatively being set by a user or otherwise provided via the STATUS terminal, is equally applicable here, as is the above description with respect to other control loop enable schemes being used.

In contrast, if VSYS is low (e.g., primary battery 101 is dying), then the mode detection circuitry is configured to enable the boost converter control (and disable the other two control loops), by setting the 2-bit status code (B3, B2) to 10. In more detail, and with further reference to the example VSYS assessment circuit 900 of FIG. 9, if VSYS is low (e.g., lower than VSYS−10%, or some other suitable threshold or tolerance), then the output of comparator 902 is high and the output of comparator 904 is low, thereby providing a 2-bit status code of 10 (bit B3 and bit B2). Responsive to VSYS being low, a 2-bit status code of 10 (B3 and B2) is received by AND-gate 509, which is configured with an inverter on its input that receives B2. The AND-gate 509 in turn generates a logic high enable signal EN1, which in turn can be used to enable the boost converter control loop. In some cases, for instance, amplifier 503 (and amplifiers 505 and/or 507, in some examples) may be enabled responsive to enable signal EN1 being high, and disabled responsive to enable signal EN1 being low. The enable logic (517, 518, and 521A-B) of the other control loops results in enable signals EN2 and EN3 being low, when enable signal EN2 is high. In the event that there is contention (e.g., both VBUB and VSYS are low), the boost converter control loop is given priority. The above relevant description with respect to the status code alternatively being set by a user or otherwise provided via the STATUS terminal, is equally applicable here, as is the above description with respect to other control loop enable schemes being used.

### Q3 Control—Scaling Circuitry

Referring to FIGS. 3 and 4, depending on which of the control loops is enabled, the transistor device Q3 can be configured based on a given control parameter corresponding to the enabled control loop. The given control parameter may be configurable (e.g., provided by the user, or a configurable constant current or voltage source) or fixed (e.g., provided by a fixed constant current or voltage source). For example, the boost input current limit reference ILIM of the boost control loop, the constant charge current reference ICHG of the buck charger control loop, and the discharge current reference ISOH of the BUB health detection control loop may all be configurable. In some such cases, for instance, each of ILIM, ICHG, and ISOH (as well as other configurable parameters, such as VCHG) can be programmed into the controller 309 or 409 via a user interface (e.g., I2C interface). In some examples, the STATUS terminal is configured as, or otherwise includes, an I2C interface. In any such cases, the given control parameter can be compared against various thresholds to effectively qualify the parameter so that transistor device Q3 can be better controlled based on that parameter qualification.

For example, and assuming the battery health detection control loop is enabled, if the customer provided a discharge current reference ISOH of <threshold_1 (e.g., 1 amp), then the scaling circuitry can be configured to set Rds_on of transistor device Q3 to 500 milliohms; if the customer provided a discharge current reference ISOH that is between threshold_1 (e.g., 1 amp) and threshold_2 (e.g., 10 amps), then the scaling circuitry can be configured to set Rds_on of transistor device Q3 to 50 milliohms; and if the customer provided a discharge current reference ISOH of >threshold_2 (e.g., 10 amps), then the scaling circuitry can be configured to set Rds_on of transistor device Q3 to 5 milliohms. Such an example allows the sense resistance provided by the transistor device Q3 to be one of three values that can be used to more accurately sense the backup battery discharge current during the BUB monitoring mode.

In another example, and assuming the boost control loop is enabled, if the customer provided a boost input current limit reference ILIM of <threshold_3 (e.g., 1 amp), then the scaling circuitry can be configured to set Rds_on of transistor device Q3 to 500 milliohms; if the customer provided a boost input current limit reference ILIM that is between threshold_3 (e.g., 1 amp) and threshold_4 (e.g., 10 amps), then the scaling circuitry can be configured to set Rds_on of transistor device Q3 to 50 milliohms; and if the customer provided a boost input current limit reference ILIM of >threshold_4 (e.g., 10 amps), then the scaling circuitry can be configured to set Rds_on of transistor device Q3 to 5 milliohms. Such an example allows the sense resistance provided by the transistor device Q3 to be one of three values that can be used to more accurately sense the boost converter current during the boost converter mode.

In another example, and assuming the buck charger control loop is enabled, if the customer provided a constant charge current reference ICHG of <threshold_5 (e.g., 1 amp), then the scaling circuitry can be configured to set Rds_on of transistor device Q3 to 500 milliohms; if the customer provided a constant charge current reference ICHG that is between threshold_5 (e.g., 1 amp) and threshold_6 (e.g., 10 amps), then the scaling circuitry can be configured to set Rds_on of transistor device Q3 to 50 milliohms; and if the customer provided a constant charge current reference ICHG of >threshold_6 (e.g., 10 amps), then the scaling circuitry can be configured to set Rds_on of transistor device Q3 to 5 milliohms. Such an example allows the sense resistance provided by the transistor device Q3 to be one of three values that can be used to more accurately sense the charging current during the buck charger mode.

Each of these examples allows the sense resistance provided by the transistor device Q3 to be one of three values. Other examples may include any number of sense resistance options (e.g., 2 or more). Also, the various thresholds to which a given control parameter is compared can vary from one example to the next, and any number of threshold values can be used. Like the given configurable control parameter, each of the given thresholds can be provided, for example, via a fixed or programmable current source, although any suitable reference circuitry can be used.

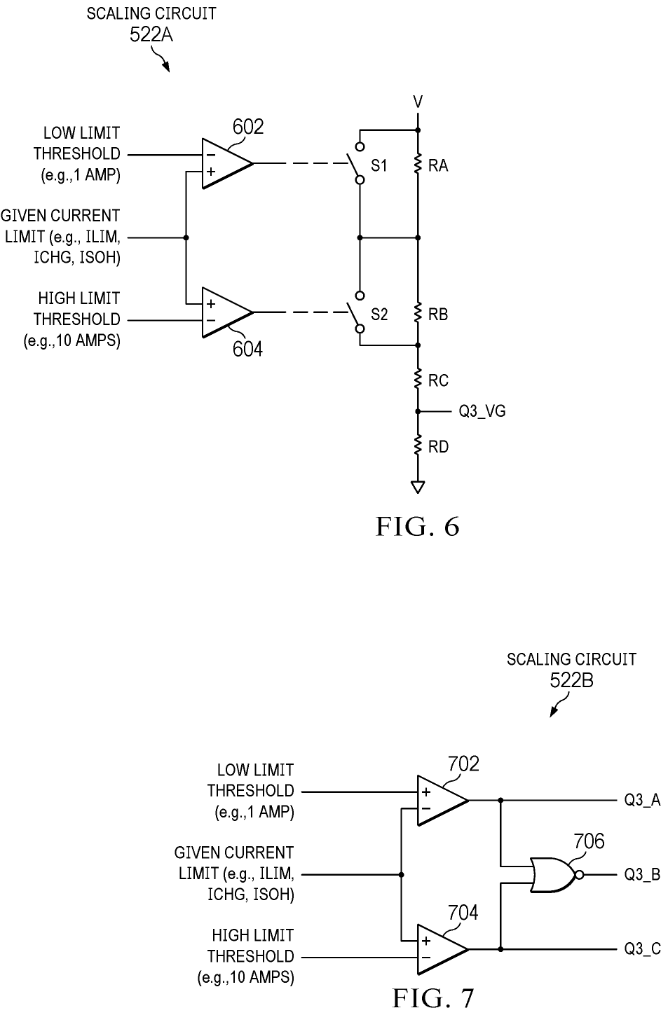

As described above, controller 309 of FIG. 3 employs scaling circuit 522A, which is configured to vary the control terminal (e.g., gate) voltage of a transistor device Q3 that is made up of a single transistor, according to one example. In one such example, the transistor device Q3 includes an NMOS power FET. By controlling the Q3 gate voltage (Q3_VG), the Rds_on value of Q3 can be scaled internally by scaling circuit 522A. In more detail, and with reference to FIG. 6, scaling circuit 522A includes a window comparator implemented with amplifiers 602 and 604, and a switchable resistive divider that includes switches S1 and S2, and resistors RA, RB, RC, and RD. As described above, a given control parameter (e.g., ILIM, ICHG, ISOH) is assessed against given thresholds. As shown in FIG. 6, the inverting input of amplifier 602 is coupled to a low limit threshold (e.g., 1 amp), and the non-inverting input of amplifier 604 is coupled to a high limit threshold (e.g., 10 amps). The given control parameter is coupled to the non-inverting input of amplifier 602 and the non-inverting input of amplifier 604.

In operation of scaling circuit 522A: if the given control parameter is less than the low limit threshold, then the outputs of comparators 602 and 604 are both low, thereby causing switches S1 and S2 to open, so as to provide a first Q3_VG voltage and a corresponding first Rds_on (e.g., 5 milliohms); if the given control parameter is between the low limit threshold and the high limit threshold, then the output of comparator 602 is high thereby causing switch S1 to close, and the output of comparator 604 is low thereby causing switch S2 to open, so as to provide a second Q3_VG voltage and a corresponding second Rds_on (e.g., 50 milliohms); and if the given control parameter is greater than the high limit threshold, then the outputs of comparators 602 and 604 are both high, thereby causing switches S1 and S2 to close, so as to provide a third Q3_VG voltage and a corresponding third Rds_on (e.g., 500 milliohms). The first Q3_VG voltage may be computed as V(RD)/(RA+RB+RC+RD); the second Q3_VG voltage may be computed as V(RD)/(RB+RC+RD); and the third Q3_VG voltage may be computed as V(RD)/(RC+RD). Other examples may be configured differently. Thus, by controlling switches S1 and S2 based on the value of the given control parameter, a specific drive voltage Q3_VG can be provided to the control terminal of transistor device Q3, to provide different Rds_on values for transistor device Q3. In some cases, however, such a configuration may not be ideal, because the sense accuracy may not be sufficient when transistor device Q3 is not fully on when providing low and intermediate Rds_on values (e.g., Rds_on values corresponding to the first and second Q3_VG voltages).

In an alternative example and as also described above, controller 409 of FIG. 4 employs scaling circuit 522B, which is configured to provide a control signal for each of a plurality of transistors making up transistor device Q3. In one such example, the transistor device Q3 includes three NMOS power FETs coupled in parallel, each having a different Rds_on value when fully on. By driving one of the control terminals (e.g., gates) of the Q3 transistor device, the Rds_on value of Q3 can be scaled internally by scaling circuit 522B. In more detail, and with reference to FIG. 7, scaling circuit 522B includes a window comparator implemented with amplifiers 702 and 704, and NOR-gate 706. As described above, a given control parameter (e.g., ILIM, ICHG, ISOH) is assessed against given thresholds. As shown in FIG. 7, the non-inverting input of amplifier 702 is coupled to a low limit threshold (e.g., 1 amp), and the inverting input of amplifier 704 is coupled to a high limit threshold (e.g., 10 amps). The given control parameter for the corresponding control loop is coupled to the inverting input of amplifier 702 and the non-inverting input of amplifier 704.

In operation of scaling circuit 522B: if the given control parameter is less than the low limit threshold, then the output of comparator 702 is high and the output of comparator 704 is low, thereby causing the output of NOR-gate 706 to be low, so as to turn on Q3_A (and turn off Q3_B and Q3_C) and thus provide a first Rds_on value (e.g., 5 milliohms); if the given control parameter is between the low limit threshold and the high limit threshold, then the output of both comparators 702 and 704 is low, thereby causing the output of NOR-gate 706 to be high, so as to turn on Q3_B (and turn off Q3_A and Q3_C) and thus provide a second Rds_on value (e.g., 50 milliohms); and if the given control parameter is greater than the high limit threshold, then the output of comparator 702 is low and the output of comparator 704 is low, so as to turn on Q3_C (and turn off Q3_A and Q3_B) and thus provide a third Rds_on value (e.g., 500 milliohms). Other examples may be configured differently. Thus, by controlling the control terminals (e.g., gates) of Q3_A, Q3_B and Q3_C based on the value of the given control parameter, different Rds_on values for transistor device Q3.

### Methodology

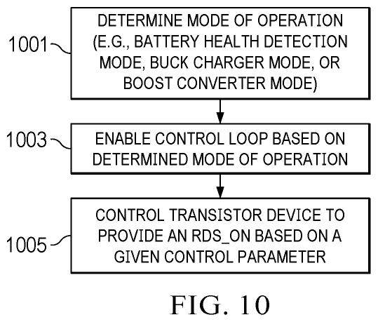

FIG. 10 illustrates a method for controlling a system having an integrated backup power architecture having a power converter, battery charger, and battery health monitoring circuitry, in an example. The method may be carried out, for example, using the system of FIG. 1, 3, or 4. In one such example case, the method is used to control a power system having a low-side switching element coupled between a ground terminal and a switching node terminal, a high-side switching element coupled between the switching node terminal and an output voltage terminal, and a transistor device (e.g., NFET) coupled between an input voltage terminal and the switching node terminal. Other backup power systems may readily benefit from the techniques described herein,

At 1001, the method includes determining a mode of operation. In some examples, the mode of operation includes one of a battery health detection mode, a backup battery charger mode, or a boost converter mode. The mode determination may be based, for example, on a backup battery voltage and a primary battery voltage (such as described with respect to FIGS. 8 and 9). The method continues at 1003, with enabling a corresponding control loop based on the determined mode of operation. In some examples, the enabling of a corresponding control loop is carried out as described with respect to FIG. 5. The method continues at 1005, with controlling the transistor device (e.g., one or more NFETs) to provide an Rds_on based on a given control parameter.

In some such cases, controlling the transistor device at 1005 includes selecting one NFET of multiple parallel-connected NFETs, and applying a gate signal to the selected NFET, thereby causing the selected NFET to provide an Rds_on that can be used as a sense resistance. In some such cases, responsive to the control parameter being within a first range, controlling the transistor device includes applying a control signal to a gate of a first NFET of the NFETs and not to a gate of any other of the NFETs. In some cases, responsive to the control parameter being within a second range, controlling the transistor device includes applying a control signal to a gate of a second NFET of the NFETs and not to a gate of any other of the NFETs.

In other such cases, controlling the transistor device at 1005 includes applying a gate signal to a single NFET, thereby causing the NFET to provide the Rds_on. In some such cases, responsive to the control parameter being within a first range, controlling the transistor device at 1005 includes applying a first control signal to a gate of the NFET, and responsive to the control parameter being within a second range, controlling the transistor device at 1005 includes applying a second control signal to a gate of the NFET, the second control signal larger in potential than that of the first control signal. In some cases, the control parameter is configurable, while in other cases the control parameter is hardcoded or otherwise fixed.

### Further Examples

Example 1 is a power system, comprising: a high-side switching element (e.g., Q2) coupled between a switching node terminal and an output voltage terminal; a transistor (e.g., Q3) coupled between an input voltage terminal and the switching node terminal; and a controller (e.g., 309 or 409) including first, second, and third control outputs, the first control output coupled to a low-side switching element control terminal, the second control output coupled to a control terminal of the high-side switching element, and the third control output coupled to a control terminal of the transistor.

Example 2 includes the power system of Example 1, wherein the controller further includes first and second control circuits, the first control circuit configured to control a low-side switching element to provide a backup battery charging mode, and the second control circuit configured to control the low-side switching element to provide a backup battery health monitoring mode.

Example 3 includes the power system of Example 2, wherein the controller further includes a third control circuit configured to control the low-side and high-side switching elements to provide a boost converter mode.

Example 4 includes the power system of any one of Examples 1 through 3, wherein the controller further includes one or more controller inputs for receiving configurable current limit parameters (e.g., power converter input current limit ILIM, a backup battery charging current ICHG, and a backup battery health detection current ISOH).

Example 5 includes the power system of Example 4, wherein the controller further includes a scaling circuit (e.g., 522A or 522B) having one or more scaling circuit inputs and a scaling circuit output, the one or more scaling circuit inputs coupled to the one or more controller inputs, and the scaling circuit output coupled to the third control output.

Example 6 includes the power system of Example 5, wherein the scaling circuit output is one of a plurality of scaling circuit outputs, and wherein the transistor is one of a plurality of transistors (e.g., Q3_A-C) coupled in parallel with each other, each of the plurality of transistors having a control terminal, and wherein each of the scaling circuit outputs is coupled to a respective one of the transistor control terminals of the plurality of transistors.

Example 7 includes the power system of any one of Examples 1 through 6, wherein the controller includes a mode detection circuit, the mode detection circuit configured to determine if a backup battery of the power system has an output voltage or resistance within a target range.

Example 8 includes the power system of Example 7, wherein the mode detection circuit is further configured to determine if a primary battery of the power system has an output voltage within a target range.

Example 9 includes the power system of any one of Examples 1 through 8, and further includes: a low-side switching element (e.g., Q1) coupled between a ground terminal and the switching node terminal, wherein a control terminal of the low-side switching element is coupled to the low-side switching element control terminal.

Example 10 is an integrated circuit package comprising the power system of any one of Examples 1 through 9.

Example 11 is a power system, comprising: a low-side switching element (e.g., Q1) coupled between a ground terminal and a switching node terminal; a high-side switching element (e.g., Q2) coupled between a switching node terminal and an output voltage terminal; an n-channel field effect transistor (NFET) (e.g., Q3) coupled between an input voltage terminal and the switching node terminal; and a controller (e.g., 309 or 409). The controller is configured to: control a low-side switching element to provide a backup battery charging mode; control the low-side switching element to provide a backup battery health monitoring mode; control the low-side and high-side switching elements to provide a boost converter mode; and control the NFET to provide a variable resistance.

Example 12 includes the power system of Example 11, wherein the controller includes a scaling circuit (e.g., 522A or 522B) configured to control the NFET to provide the variable resistance.

Example 13 includes the power system of Example 11 or 12, wherein the controller includes a first control circuit, a second control circuit, and a third control circuit, the first control circuit configured to control the low-side switching element to provide the backup battery charging mode, the second control circuit configured to control the low-side switching element to provide the backup battery health monitoring mode, and the third control circuit configured to control the low-side and high-side switching elements to provide the boost converter mode.

Example 14 includes the power system of any one of Examples 11 through 13, wherein the controller includes a controller input for receiving a control parameter, and the controller is configured to control the NFET based on the control parameter, to provide the variable resistance.

Example 15 includes the power system of Example 14, wherein the NFET is one of a plurality of NFETs (e.g., Q3_A-C of FIG. 4) coupled in parallel with each other, and the controller is configured to: responsive to the control parameter being within a first range, applying a control signal to a gate of a first NFET of the plurality of NFETs to turn on the first NFET and not to a gate of any other of the NFETs of the plurality of NFETs; and responsive to the control parameter being within a second range, applying a second control signal to a gate of a second NFET of the plurality of NFETs to turn on the second NFET and not to a gate of any other of the NFETs of the plurality of NFETs.

Example 16 includes the power system of Example 14, wherein the controller is configured to: responsive to the control parameter being within a first range, applying a first control signal to a gate of the NFET (e.g., Q3 of FIG. 3); and responsive to the control parameter being within a second range, applying a second control signal to the gate of the NFET, the second control signal having a potential that is different from that of the first control signal.

Example 17 includes the power system of any one of Examples 14 through 16, wherein the control parameter is configurable.

Example 18 includes the power system of any one of Examples 11 through 16, wherein the controller includes a mode detection circuit (e.g., 800 and 900), the mode detection circuit configured to: responsive to determining that a backup battery of the power system has an output voltage or internal resistance outside a target range, enable the backup battery charging mode; responsive to determining that a primary battery of the power system has an output voltage or internal resistance outside a target range, enable the boost converter mode; and responsive to determining that the backup battery and the primary battery each has an output voltage or internal resistance within a corresponding target range, enable the backup battery health monitoring mode.

Example 19 is an integrated circuit package comprising the power system of any one of Examples 11 through 18.

Example 20 is an integrated circuit package comprising the power system of any one of Examples 11 through 18, except for the low-side switching element, which is external to the integrated circuit package.

Example 21 is a method for controlling a power system, the power system having a low-side switching element coupled between a ground terminal and a switching node terminal, a high-side switching element coupled between the switching node terminal and an output voltage terminal, and an n-channel field effect transistor (NFET) coupled between an input voltage terminal and the switching node terminal, the method comprising: determining, by a controller, a mode of operation, based on a primary battery voltage and a backup battery voltage, the mode of operation including one of a battery health detection mode, a backup battery charger mode, or a boost converter mode; enabling, by the controller, a corresponding control loop based on the determined mode of operation; and controlling, by the controller, the NFET to provide a drain-to-source on-resistance (Rds_on) based on a given control parameter.

Example 22 includes the method of Example 21, wherein controlling the NFET includes selecting one NFET of multiple NFETs, and applying a gate signal to the selected NFET, thereby causing the selected NFET to provide the Rds_on.

Example 23 includes the method of Example 21, wherein controlling the NFET includes applying a gate signal to the NFET, thereby causing the NFET to provide the Rds_on.

Example 24 includes the method of any one of Examples 21 through 23, wherein the NFET is one of a plurality of NFETs coupled in parallel with each other, and controlling the NFET includes: responsive to the control parameter being within a first range, applying a first control signal to a gate of a first NFET of the NFETs to turn on the first FET and not to a gate of any other of the NFETs; and responsive to the control parameter being within a second range, applying a second control signal to a gate of a second NFET of the NFETs to turn on the second FET and not to a gate of any other of the NFETs.

Example 25 includes the method of any one of Examples 21 through 23, wherein controlling the NFET includes: responsive to the control parameter being within a first range, applying a first control signal to a gate of the NFET; and responsive to the control parameter being within a second range, applying a second control signal to the gate of the NFET, the second control signal larger in potential than that of the first control signal.

Example 26 includes the method of any one of Examples 21 through 25, wherein the control parameter is configurable.

Example 27 includes the method of any one of Examples 21 through 26, wherein the high-side switching element and the NFET are internal to an integrated circuit, and the low-side switching element is external to the integrated circuit.

Example 28 includes the subject matter of any one of Examples 1 through 27, wherein the power system is part of an automotive telematics system.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (Si), a silicon carbide substrate (SiC), a gallium nitride substrate (GaN) or a gallium arsenide substrate (GaAs).

References herein to a field effect transistor (FET) being “ON” means that the conduction channel of the FET is present and drain current may flow through the FET. References herein to a FET being “OFF” means that the conduction channel is not present and drain current does not flow through the FET. A FET that is OFF, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

Modifications are possible in the described embodiments, and other embodiments are possible, within the scope of the claims.

What is claimed is:

1. A power system, comprising:
a high-side switching element coupled between a switching node terminal and an output voltage terminal;
a transistor coupled between an input voltage terminal and the switching node terminal; and
a controller including first, second, and third control outputs, the first control output coupled to a low-side switching element control terminal, the second control output coupled to a control terminal of the high-side switching element, and the third control output coupled to a control terminal of the transistor.

2. The power system of claim 1, wherein the controller further includes first and second control circuits, the first control circuit configured to control a low-side switching element to provide a backup battery charging mode, and the second control circuit configured to control the low-side switching element to provide a backup battery health monitoring mode.

3. The power system of claim 2, wherein the controller further includes a third control circuit configured to control the low-side and high-side switching elements to provide a boost converter mode.

4. The power system of claim 1, wherein the controller further includes one or more controller inputs for receiving configurable current limit parameters.

5. The power system of claim 4, wherein the controller further includes a scaling circuit having one or more scaling circuit inputs and a scaling circuit output, the one or more scaling circuit inputs coupled to the one or more controller inputs, and the scaling circuit output coupled to the third control output.

6. The power system of claim 5, wherein the scaling circuit output is one of a plurality of scaling circuit outputs, and wherein the transistor is one of a plurality of transistors coupled in parallel with each other, each of the plurality of transistors having a control terminal, and wherein each of the scaling circuit outputs is coupled to a respective one of the transistor control terminals of the plurality of transistors.

7. The power system of claim 1, wherein the controller includes a mode detection circuit, the mode detection circuit configured to determine if a backup battery of the power system has an output voltage or resistance within a target range.

8. The power system of claim 7, wherein the mode detection circuit is further configured to determine if a primary battery of the power system has an output voltage within a target range.

9. The power system of claim 1, comprising: a low-side switching element coupled between a ground terminal and the switching node terminal, wherein a control terminal of the low-side switching element is coupled to the low-side switching element control terminal.

10. An integrated circuit package comprising the power system of claim 1.

11. A power system, comprising:
a low-side switching element coupled between a ground terminal and a switching node terminal;
a high-side switching element coupled between a switching node terminal and an output voltage terminal;
an n-channel field effect transistor (NFET) coupled between an input voltage terminal and the switching node terminal; and
a controller configured to
control a low-side switching element to provide a backup battery charging mode,
control the low-side switching element to provide a backup battery health monitoring mode,
control the low-side and high-side switching elements to provide a boost converter mode, and
control the NFET to provide a variable resistance.

12. The power system of claim 11, wherein the controller includes a scaling circuit configured to control the NFET to provide the variable resistance.

13. The power system of claim 12, wherein the controller includes a first control circuit, a second control circuit, and a third control circuit, the first control circuit configured to control the low-side switching element to provide the backup battery charging mode, the second control circuit configured to control the low-side switching element to provide the backup battery health monitoring mode, and the third control circuit configured to control the low-side and high-side switching elements to provide the boost converter mode.

14. The power system of claim 11, wherein the controller includes a controller input for receiving a control parameter, and the controller is configured to control the NFET based on the control parameter, to provide the variable resistance.

15. The power system of claim 14, wherein the NFET is one of a plurality of NFETs coupled in parallel with each other, and the controller is configured to:
responsive to the control parameter being within a first range, applying a first control signal to a gate of a first NFET of the plurality of NFETs to turn on the first NFET and not to a gate of any other of the NFETs of the plurality of NFETs; and
responsive to the control parameter being within a second range, applying a second control signal to a gate of a second NFET of the plurality of NFETs to turn on the second NFET and not to a gate of any other of the NFETs of the plurality of NFETs.

16. The power system of claim 14, wherein the controller is configured to:
responsive to the control parameter being within a first range, applying a first control signal to a gate of the NFET; and
responsive to the control parameter being within a second range, applying a second control signal to the gate of the NFET, the second control signal having a potential that is different from that of the first control signal.

17. The power system of claim 14, wherein the control parameter is configurable.

18. The power system of claim 11, wherein the controller includes a mode detection circuit, the mode detection circuit configured to:
responsive to determining that a backup battery of the power system has an output voltage or internal resistance outside a target range, enable the backup battery charging mode;
responsive to determining that a primary battery of the power system has an output voltage or internal resistance outside a target range, enable the boost converter mode; and
responsive to determining that the backup battery and the primary battery each has an output voltage or internal resistance within a corresponding target range, enable the backup battery health monitoring mode.

19. An integrated circuit package comprising the power system of claim 11.

20. A method for controlling a power system, the power system having a low-side switching element coupled between a ground terminal and a switching node terminal, a high-side switching element coupled between the switching node terminal and an output voltage terminal, and an n-channel field effect transistor (NFET) coupled between an input voltage terminal and the switching node terminal, the method comprising:
determining, by a controller, a mode of operation, based on a primary battery voltage and a backup battery voltage, the mode of operation including one of a battery health detection mode, a backup battery charger mode, or a boost converter mode;
enabling, by the controller, a corresponding control loop based on the determined mode of operation; and
controlling, by the controller, the NFET to provide a drain-to-source on-resistance (Rds_on) based on a given control parameter.

21. The method of claim 20, wherein controlling the NFET includes selecting one NFET of multiple NFETs, and applying a gate signal to the selected NFET, thereby causing the selected NFET to provide the Rds_on.
